(19) United States
(12) Patent Application Publication
(10) Pub. No.: US 2007/0103821 A1
(43) Pub. Date: May 10, 2007

(54) Motor overheat warning device for a hoisting winder

(76) Inventor: Shih Jyi Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/435,859

(22) Filed: May 18, 2006

(30) Foreign Application Priority Data
Nov. 9, 2005 (TW) 094139210

(51) Int. Cl. H02H 7/08

(52) U.S. Cl. 361/26

(57) ABSTRACT

A motor overheat warning device for a hoisting winder includes a temperature control switch provided in the built-up space of a motor. The temperature control switch is electrically connected with a warning apparatus. When the inner temperature of the motor rises higher than a preset value, the warning apparatus will be electrically connected to give out warning signals to let the operator know the overheat situation and timely decide to stop operating of the hoisting winder, able to insure safety in operating and using of the hoisting winder.

### BACKGROUND OF THE INVENTION

1. Field of the Invention

This invention relates to a motor overheat warning device for a hoisting winder, particularly to one provided with a temperature control switch in the built-up space of a motor. The temperature control switch is electrically connected with a warning apparatus. When the temperature of the motor becomes higher than a preset value, the temperature control switch will transmit electricity to the warning apparatus for giving out warning signals to let the operator know the overheat situation of the motor and decide to stop operating of the hoisting winder at an opportune moment.

2. Description of the Prior Art

A hoisting winder, also called as an electric winch or a power winch, is a hoisting apparatus able to retract or release steel ropes for slinging up or lowering down heavy loads. A hoisting winder can be positioned on a high building for slinging or lowering goods, or assembled on a jeep or a cross-country vehicle for dragging other vehicles or for rescuing people in dangerous places. A conventional hoisting winder 1 as shown in FIG. 1 includes an outer casing 10 provided at. one side and a cable drum 20 positioned in the interior of the other side, with a steel rope 21 extending out of the cable drum 20 and having its front end fixed with a hook 22, and a motor 30 is installed at one side of the cable drum 20. In assembling, the outer casing 10 is completely covered around the motor 30, having its rear side combined with a control box 40 in which various electric circuits are disposed. The control box 40 is connected with an electric wire provided thereon with an electric adapter 41, and a hand controller 50 positioned in front of the outer casing 10 is provided with an electric wire 52 extending outward and provided thereon with an electric adapter 51 to be connected with the electric adapter 41 of the control box 40. Thus, by pressing the press buttons of the hand controller 50, the motor 30 can be controlled to start or stop operating and rotate clockwise or counterclockwise to achieve the effect of wire remote control of the hoisting winder 1.

The motor of the conventional hoisting winder functions to output power and, through speed reduction, drive the cable drum to rotate clockwise or counterclockwise for retracting or releasing the steel rope to sling up or lower down heavy loads. When the motor of the hoisting winder is operated, it will bear extremely huge torsional force and its inner temperature is likely to rise and cause overheat. Especially, when the hoisting winder is employed for slinging up excessively heavy loads or for dragging a load in dangerous places, the motor current may suddenly increase, relatively causing overheat. However, when the motor continues to operate, the operator of the hoisting winder is not aware of the inner temperature of the motor; therefore, when overheat of the motor occurs, the operator cannot timely stop operating of the hoisting winder, which is likely to cause damage and burning out of the components of the hoisting winder or endanger lives and properties due to falling down of heavy loads.

In view of this situation, a current protecting device is provided on the motor circuit of the conventional hoisting winder for timely breaking the circuit and stopping the motor if overheat of the motor should occur. However, the situation of a work site of the hoisting winder may be changeful and the hoisting winder has heavy loads suspended in the air; therefore, it is not safe to stop the motor automatically by abruptly cutting off the electricity under an uncontrolled condition. Furthermore, sudden increase of motor current is not necessarily translated into overheat of the motor. For instance, when crossing a big pit in the ground, the torsional force of the motor of a car will suddenly augment and the motor current will increase abruptly, but it does not necessarily mean overheat of the motor and such a situation of abrupt current increase may disappear soon. Therefore, if electricity is cut off and the motor of the hoisting winder is stopped operating abruptly by the current protecting device, the sudden action of instantly stopping the motor may cause damage to the heavy loads suspended in the air or endanger people around.

### SUMMARY OF THE INVENTION

The objective of the invention is to offer a motor overheat warning device for a hoisting winder, able to give out warning signals to let the operator know the overheat situation of the motor and decide to stop operating of the hoisting winder at an opportune moment.

The feature of the invention is a temperature control switch provided in the built-up space of the motor. The temperature control switch is electrically connected with a warning apparatus. When the temperature control switch induces that the inner temperature of the motor reaches a set value, it will transmit electricity to the warning apparatus for giving out warning signals to let the operator know the overheat situation and decide to stop operating of the hoisting winder at proper time.

### BRIEF DESCRIPTION OF DRAWINGS

This invention will be better understood by referring to the accompanying drawings, wherein:

FIG. 1 is an exploded perspective view of a conventional hoisting winder; and

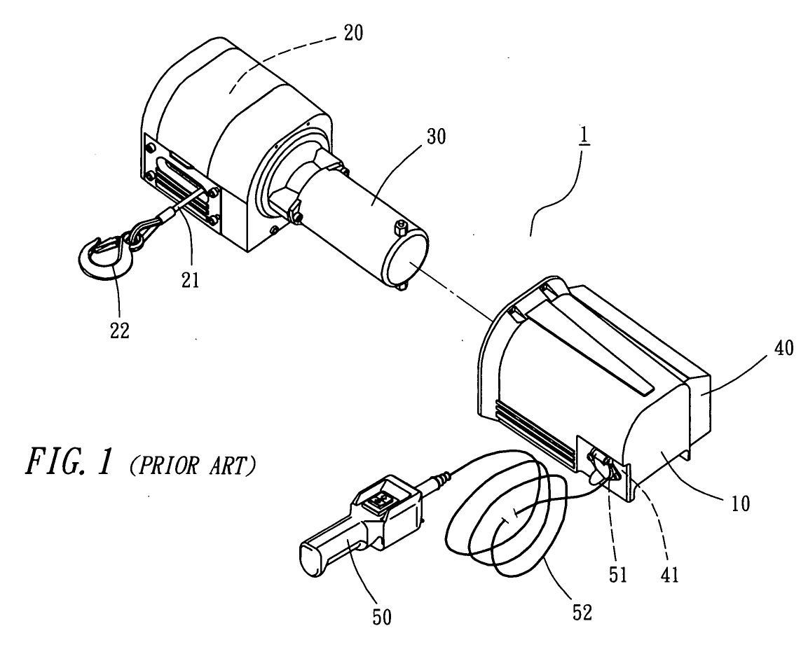

FIG. 2 is an electrically connecting diagram of a motor overheat warning device for a hoisting winder in the present invention.

### DETAILED DESCRIPTION OF THE PREFERRED EMBODIEMTN

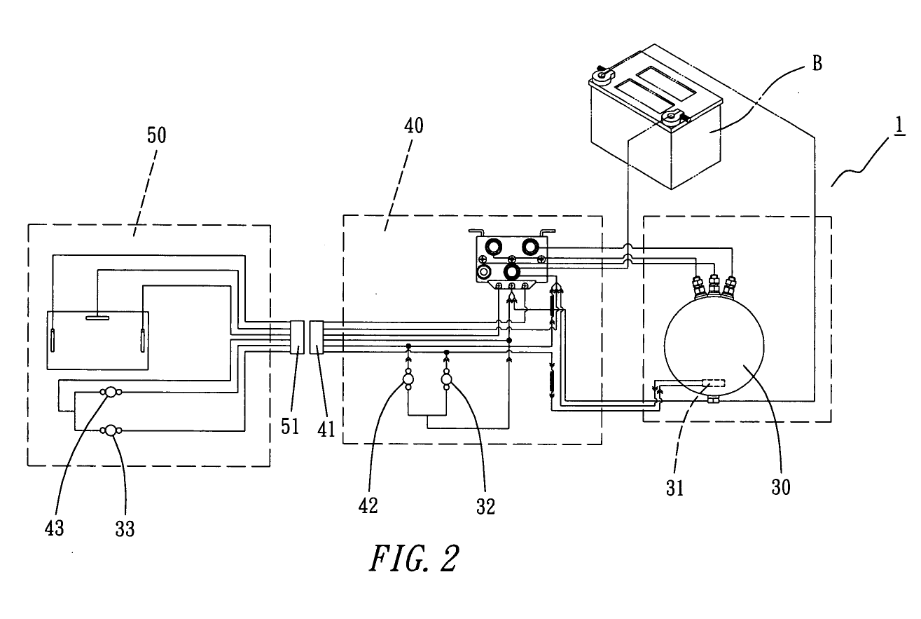

A preferred embodiment of a motor overheat warning device for a hoisting winder 1 in the present invention, as shown in FIG. 2, includes a motor 30, a temperature control switch 31, a control box 40 and a hand controller 50 as main components combined together.

The temperature control switch 31 made of two metal strips is installed in the built-up space of the motor 30 and connected with an electric circuit for carrying out switching. When the temperature of the motor 30 exceeds a preset value, the two metal strips, due to different thermal expansion coefficients, will become curved and make electric connection, and when the temperature of the motor 30 drops below the preset value, the two metal strips will straighten again and break the circuit.

The control box 40 is electrically connected with the temperature control switch 31, having its outer surface provided with a green power source lamp 42 and a red overheat warning lamp 32. The control box 40 is further provided with an electric connector 41 to be connected with the electric connector 51 of the hand controller 50 that has its faceplate disposed thereon with a green power source lamp 43 and a red overheat warning lamp 33.

In using, the hoisting winder is first supplied with electricity by a power source B, such as a vehicle battery. When the press button of the hand controller 50 is pressed, the power source lamp 42, 43 of the control box 40 and the hand controller 50 will be lit up to indicate that the hoisting winder 1 is already powered, able to be operated to retract or release the steel rope for slinging up or lowering down heavy loads. At this time, the temperature control switch 31 is not yet electrically connected, so the overheat warning lamps 32, 33 are not lit up. When the hoisting winder 1 is continuously operated and, due to various factors, the inner temperature of the motor 30 rises too high, the temperature control switch 31 will be electrically connected and the two overheat warning lamps 32, 33 will be lit up to let the operator know the overheat situation of the motor 30 and decide to stop operating of the hoisting winder 1 at a proper moment. However, the hoisting winder 1 cannot be abruptly stopped operating at the moment when heavy loads or people around are in dangerous situations. Under the circumstances, it is up to t h e operator to expediently decide when to stop operating of the hoisting winder 1 for safety.

To sum up, this invention is mainly employed for timely giving out overheat signals of the motor to let the operator know the overheat situation and timely stop the hoisting winder by means of the hand controller, thus insuring safety in operating and using of the hoisting winder.

In addition, there are three points about the structure of the invention that should be especially mentioned as follows

1. The temperature control switch of this invention is employed for detecting or sensing the inner temperature of the motor so as to timely give out warning signals, but any switch that can detect or sense the inner temperature of a motor can be used as the temperature control switch of this invention, not limited to one made of the two metal strips as described above.

2. The overheat warning lamp of this invention is a warning apparatus for giving out warning signals with red light or red flash, but it is also inclusive of one that is able to give out warning sounds or warning vibration after electrically connected.

3. Though the temperature control switch of this invention is located in the built-up space of the motor, it can be positioned outside the motor, so long as it can sense accurately the inner temperature of the motor.

While the preferred embodiment of the invention has been described above, it will be recognized and understood that various equivalent structures and modifications may be made therein and the appended claims are intended to cover all such equivalent structures and modifications that may fall within the spirit and scope of the invention.

I claim:

1. A motor overheat warning device for a hoisting winder, said device comprising a motor and a cable drum, said cable drum driven by said motor to rotate clockwise or counterclockwise for retracting or releasing a steel rope to sling up or lower down heavy loads; and,
Characterized by a temperature control switch provided in the built-up space of said motor, said temperature control switch electrically connected with a warning apparatus, said temperature control switch transmitting electricity to said warning apparatus when said temperature control switch senses that the inner temperature of said motor reaches a set value, said warning apparatus simultaneously giving out warning signals to let the operator know the overheat situation of said motor.

2. The motor overheat warning device for a hoisting winder as claimed in claim 1, wherein said temperature control switch is made of two metal strips, said two metal strips becoming curved to make electric connection when the temperature of said motor rises higher than a preset value, said two metal strips straightening again to break the circuit when the temperature of said motor drops down below the preset value.

3. The motor overheat warning device for a hoisting winder as claimed in claim 1, wherein said warning apparatus is a warning lamp for giving out warning signals.
